(19) United States
(12) Patent Application Publication
(10) Pub. No.: US 2026/0336012 A1
(43) Pub. Date: Oct. 29, 2026

(54) PIPELINE ALL-POSITION SUBMERGED ARC WELDING METHOD, DEVICE, SYSTEM AND STORAGE MEDIUM

(71) Applicant: HUBEI UNIVERSITY OF ARTS AND SCIENCE, Xiangyang (CN)

(72) Inventors: Zhongren WANG, Xiangyang (CN); Hongbo YANG, Xiangyang (CN); Wen ZHANG, Xiangyang (CN); Tielin SHI, Xiangyang (CN); Wanbo LIU, Xiangyang (CN); Houkun ZHANG, Xiangyang (CN); Xilin KE, Xiangyang (CN); Wenlong LI, Xiangyang (CN); Rongli ZHAO, Xiangyang (CN); Yuebin ZHOU, Xiangyang (CN); Hu LONG, Xiangyang (CN); Xiao ZHAO, Xiangyang (CN)

(73) Assignee: HUBEI UNIVERSITY OF ARTS AND SCIENCE, Xiangyang (CN)

(21) Appl. No.: 19/262,970

(22) Filed: Jul. 8, 2025

Related U.S. Application Data
(63) Continuation of application No. PCT/CN2025/096953, filed on May 23, 2025.

(30) Foreign Application Priority Data
Apr. 24, 2025 (CN) 202510524021.1

(51) Int. Cl. B23K 9/18; B23K 37/053

(52) U.S. Cl. CPC B23K 9/18; B23K 37/053

(57) ABSTRACT

A pipeline all-position submerged arc welding method includes: performing centering and correcting on a flux pocket device, and aligning a welding gun with a cover plate hole of a flux pocket box on the flux pocket device; when the welding gun is aligned with the cover plate hole, adjusting a flux hopper to the target height; when the flux hopper reaches the target height, controlling the solenoid valve inside the flux hopper to adjust the flux accumulation amount according to the capacitance signal fed back by the capacitance probe inside the flux pocket box; and when the flux accumulation amount reaches a preset accumulation amount threshold, starting the welding gun to start an arc and synchronously moving the welding gun and a cover plate of the flux pocket box until welding is completed.

### CROSS-REFERENCE TO RELATED APPLICATIONS

This application is a continuation application of International Application No. PCT/CN2025/096953, filed on May 23, 2025, which claims priority to Chinese Patent Application No. 202510524021.1, filed on Apr. 24, 2025. The disclosures of the above-mentioned applications are incorporated herein by reference in their entireties.

### TECHNICAL FIELD

The present application relates to the technical field of automated welding, and in particular to a pipeline all-position submerged arc welding method, a device, a system and a storage medium.

### BACKGROUND

In welding operations under complex working conditions such as chemical pipelines, pipeline welding faces the need for all-position welding, including vertical welding, overhead welding and other welding positions. Especially for non-rotatable chemical pipelines, traditional welding methods are difficult to meet the requirements of welding quality and efficiency.

At present, traditional pipeline submerged arc welding technology usually adopts the method of “pipeline rotation, welding gun not moving”, which is suitable for most standard pipeline welding conditions. However, at chemical construction sites, especially in pressure pipeline welding, the pipeline cannot rotate, resulting in the need for all-position welding. In addition, the flux supply is usually controlled by the adjustment of the physical structure.

There are many limitations in existing practices. Firstly, in the all-position welding of non-rotatable pipelines with traditional welding technology, the welding quality and efficiency are difficult to guarantee, and the porosity defects are difficult to effectively prevent. Secondly, in the existing flux anti-falling device, in all-position welding conditions such as vertical welding and overhead welding, the flux may be unevenly accumulated due to gravity, or even fall off, resulting in substandard welding quality. In addition, the existing device lacks real-time adjustment capability, and the flux supply cannot be intelligently adjusted according to the real-time changes of flux accumulation. The structure is complex and difficult to maintain, which increases the instability and maintenance cost during welding. Therefore, how to achieve uniform supply of flux in all-position and precise synchronous control of welding paths has become an urgent problem to be solved.

The above content is only configured to assist in understanding the technical solution of the present application, and does not mean that the above content is recognized as related art.

### SUMMARY

The main purpose of the present application is to provide a pipeline all-position submerged arc welding method, a device, a system and a storage medium, aiming to solve the technical problem of how to achieve uniform supply of flux in all positions and precise synchronous control of welding paths.

In order to achieve the above purpose, the present application provides a pipeline all-position submerged arc welding method, including:
performing centering and correcting on a flux pocket device, and aligning a welding gun with a cover plate hole of a flux pocket box on the flux pocket device;
in response to that the welding gun is aligned with the cover plate hole, adjusting a flux hopper to a target height;
in response to that the flux hopper reaches the target height, controlling a solenoid valve inside the flux hopper to adjust a flux accumulation amount according to a capacitance signal fed back by a capacitance probe inside the flux pocket box; and
in response to that the flux accumulation amount reaches a preset accumulation amount threshold, starting the welding gun to start an arc and synchronously moving the welding gun and the cover plate of the flux pocket box until welding is completed.

In an embodiment, the performing centering and correcting on the flux pocket device and aligning the welding gun with the cover plate hole of the flux pocket box on the flux pocket device includes:
controlling a laser to project a laser line along a V-shaped groove of a pipeline to be welded;
acquiring a weld image containing the laser line, and extracting an edge coordinate of the laser line in the weld image;
calculating an offset distance between the edge coordinate and a weld center line in the weld image;
aligning the flux pocket device with the weld center line according to the offset distance; and
in response to that the flux pocket device is aligned with the weld center line, aligning the welding gun with the cover plate hole of the flux pocket box on the flux pocket device.

In an embodiment, the acquiring the weld image containing the laser line and extracting the edge coordinate of the laser line in the weld image includes:
acquiring the weld image containing the laser line, and graying and Gaussian filtering the weld image to obtain a target image;
calculating a gradient amplitude and a gradient direction of each pixel point in the target image;
performing non-maximum suppression on the pixel point to obtain a suppressed pixel point according to the gradient amplitude and the gradient direction;
screening the suppressed pixel point by a dual threshold detection algorithm, marking a pixel point with a gradient amplitude greater than a preset high gradient threshold as a strong edge point, and marking a pixel point with a gradient amplitude between a preset low gradient threshold and the preset high gradient threshold as a weak edge point; and
obtaining the edge coordinate of the laser line according to the weak edge point, the strong edge point and the weld image.

In an embodiment, the obtaining the edge coordinate of the laser line according to the weak edge point, the strong edge point and the weld image includes:
connecting the weak edge point with adjacent strong edge point based on an edge connection algorithm to form a continuous edge profile;
fitting a straight line equation of the edge profile by Hough transform; and
determining the edge coordinate of the laser line according to an intersection of the straight line equation and a boundary of the weld image.

In an embodiment, the aligning the flux pocket device with the weld center line according to the offset distance includes:
calculating a lateral adjustment amount of the flux pocket device according to the offset distance and a preset proportional gain coefficient;
generating a pulse signal based on the lateral adjustment amount; and
driving a motor of the flux pocket device to perform a lateral displacement at a preset adjustment cycle according to the pulse signal until an actual offset distance between the weld center line and the flux pocket device is less than a preset alignment accuracy threshold, and completing alignment.

In an embodiment, the in response to that the welding gun is aligned with the cover plate hole, adjusting the flux hopper to the target height includes:
in response to that the welding gun is aligned with the cover plate hole, measuring a distance between the flux hopper and a pipe to be welded by a rangefinder camera; and
calculating the target height of the flux hopper based on the distance, a preset flux fluidity parameter and a preset hose diameter parameter, and adjusting the flux hopper to the target height.

In an embodiment, the in response to that the flux hopper reaches the target height, controlling the solenoid valve inside the flux hopper to adjust the flux accumulation amount according to the capacitance signal fed back by the capacitance probe inside the flux pocket box includes:
in response to that the flux hopper reaches the target height, obtaining multiple capacitance signals fed back by multiple capacitance probes inside the flux pocket box;
performing weighted averaging and filtering on the capacitance signals to obtain an average feedback signal;
in response to that the average feedback signal does not reach a preset signal threshold, keeping the solenoid valve inside the flux hopper open; and
in response to that the average feedback signal reaches the preset signal threshold, closing the solenoid valve to adjust the flux accumulation amount.

In addition, in order to achieve the above purpose, the present application also provides a pipeline all-position submerged arc welding device, including:
an alignment module configured to perform centering and deviation correction on a flux pocket device, and align a welding gun with a cover plate hole of a flux pocket box on the flux pocket device;
a hopper adjustment module configured to adjust the flux hopper to a target height in response to that the welding gun is aligned with the cover plate hole;
a flux control module configured to control a solenoid valve inside the flux hopper to adjust a flux accumulation amount according to a capacitance signal fed back by a capacitance probe inside the flux pocket box in response to that the flux hopper reaches the target height; and
a welding module configured to start the welding gun to start an arc and synchronously move the welding gun and the cover plate of the flux pocket box until a welding is completed in response to that the flux accumulation amount reaches a preset accumulation amount threshold.

In addition, in order to achieve the above purpose, the present application also provides a submerged arc automatic welding system, including:
a circular track, a pipe to be welded, a flux pocket device, a welding gun, a flux hopper, a flux hopper fixed base, a rangefinder camera, a welding trolley circular track base, a welding wire reel, a welding trolley, a welding gun adjustment module, a flux baffle moving module, a flux baffle, a flux pocket box, a flux pocket box driving device, a flux hopper lifting module, a small air pump and a solenoid valve;
wherein the circular track is mounted at an outer surface of the pipe to be welded, and the flux pocket device is mounted at a weld of the pipe to be welded through a magnetic wheel.

In addition, in order to achieve the above purpose, the present application also provides a storage medium, the storage medium is a computer-readable storage medium, a computer program is stored on the storage medium, and when the computer program is executed by a processor, the pipeline all-position submerged arc welding method described above is implemented.

In addition, in order to achieve the above purpose, the present application also provides a computer program product, including a computer program, and when the computer program is executed by a processor, the pipeline all-position submerged arc welding method described above is implemented.

One or more technical solutions provided in the present application have at least the following technical effects.

Firstly, the system performs centering and deviation correction on the flux pocket device, and aligns the welding gun with the cover plate hole of the flux pocket box, so as to avoid welding defects caused by welding gun deviation during welding and improve welding quality and efficiency.

Secondly, when the welding gun is aligned with the cover plate hole, the system calculates the target height according to a preset formula, and then controls the lifting device driven by the motor to adjust the flux hopper to the height to ensure that the flux can flow smoothly into the flux pocket box, avoiding poor flux flow or uneven accumulation due to inappropriate height. Then, after the flux hopper reaches the target height, the system obtains the capacitance signal fed back by multiple capacitance probes in the flux pocket box, controls the opening and closing of the solenoid valve according to the capacitance signal, realizes precise control of the flux accumulation amount, and ensures that the flux accumulation amount always meets the welding process requirements.

Finally, when the flux accumulation reaches the preset accumulation threshold, the system starts the welding gun arc and synchronously moves the welding gun and the cover of the flux pocket box until the welding is completed, realizing uniform supply of flux in all positions and precise synchronous control of the welding path, and avoiding welding defects caused by uneven flux and ensuring the continuity and stability of the welding process.

### BRIEF DESCRIPTION OF THE DRAWINGS

The drawings herein are incorporated into the specification and constitute a part of the specification, showing embodiments that conform to the present application, and are configured to explain the principles of the present application together with the specification.

In order to illustrate the technical solutions in the embodiments of the present application or in the related art more clearly, the following briefly introduces the accompanying drawings required for the description of the embodiments or the related art. Obviously, for those skilled in the art, other drawings can also be obtained according to the structures shown in these drawings without any creative effort.

FIG. 1 is a flowchart of a pipeline all-position submerged arc welding method according to an embodiment of the present application.

FIG. 2 is a schematic structural diagram of a flux pocket device of the pipeline all-position submerged arc welding method according to an embodiment of the present application.

FIG. 3 is a schematic structural diagram of a flux rotating interface of the pipeline all-position submerged arc welding method according to an embodiment of the present application.

FIG. 4 is a schematic diagram of the distribution of capacitance probes in the flux bagging device of the pipeline all-position submerged arc welding method according to an embodiment of the present application.

FIG. 5 is a flowchart of the pipeline all-position submerged arc welding method according to another embodiment of the present application.

FIG. 6 is a schematic structural diagram of modules of a pipeline all-position submerged arc welding device according to an embodiment of the present application.

FIG. 7 is a schematic structural diagram of a submerged arc automatic welding system according to an embodiment of the present application.

The realization of the objective, functional characteristics, and advantages of the present application are further described with reference to the accompanying drawings and in conjunction with embodiments.

### DETAILED DESCRIPTION OF THE EMBODIMENTS

It should be understood that the specific embodiments described herein are only configured to explain the technical solution of the present application and are not configured to limit the present application.

In order to better understand the technical solution of the present application, a detailed description will be given below in conjunction with the drawings and specific embodiments of the specification.

In chemical pipeline welding, facing the requirements of all-position welding such as vertical welding and overhead welding, especially non-rotatable pressure pipelines, the traditional “pipeline rotation, welding gun does not move” submerged arc welding technology is difficult to meet the quality and efficiency requirements. The existing practice is prone to porosity defects during all-position welding, and the flux may be unevenly accumulated or fall off due to gravity, resulting in reduced welding quality. In addition, the lack of the ability to adjust the flux supply in real time, the existing device structure is complex and difficult to maintain, which increases the instability and cost of the welding process.

The main solution of the embodiment of the present application is: the system first performs centering and deviation correction on the flux pocket device and aligns the welding gun with the cover plate hole to avoid welding defects and improve quality and efficiency; then after the welding gun is aligned, the system calculates the target height according to the formula and adjust the height of the flux hopper to ensure smooth flow of the flux; then after the funnel reaches the target height, the system control the solenoid valve according to the feedback signal of the capacitance probe to accurately control the flux accumulation; finally, when the flux accumulation reaches the standard, the system starts the welding gun to start the arc and synchronously move the welding gun and the cover plate to complete the welding.

The execution subject of the embodiment of the present application can be a computing service device with data processing, network communication and program running functions, such as a tablet computer, a personal computer, a mobile phone, etc., or an electronic device that can realize the above functions, a submerged arc automatic welding system, etc. The following takes the submerged arc automatic welding system as an example to illustrate this embodiment and the following embodiments.

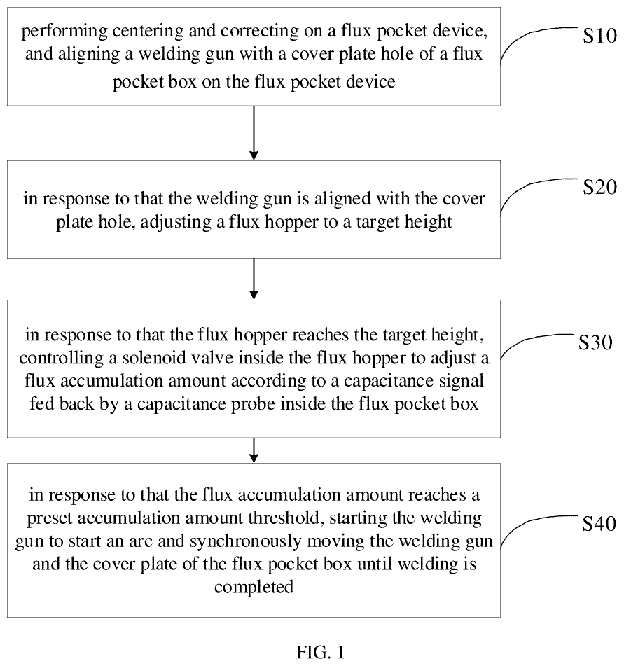

Based on this, the embodiment of the present application provides a pipeline all-position submerged arc welding method, referring to FIG. 1, FIG. 1 is a flowchart of a pipeline all-position submerged arc welding method according to an embodiment of the present application.

In the present embodiment, the pipeline all-position submerged arc welding method includes steps S10 to S40.

Step S10, performing centering and correcting on a flux pocket device, and aligning a welding gun with a cover plate hole of a flux pocket box on the flux pocket device.

The flux pocket device is a assembly that contains and supplies flux, ensuring that the flux can be evenly and stably covered in the welding area during welding. The device is mounted at the surface of the pipeline to be welded through a magnetic wheel system, and can automatically adjust the suction force according to the shape and material of the pipeline to ensure the stability and reliability of the device. The main part of the flux pocket device is a housing with sufficient strength and high temperature resistance, and the shape of the flux pocket device is designed in an arc shape with the contact surface of the pipeline to adapt to pipelines of different diameters and shapes.

The welding gun is configured to complete the welding operation, mounted at the welding trolley, and the welding gun adjustment mechanism realizes multi-degree-of-freedom adjustment such as up and down, left and right movement and rotation. The welding gun enters the inside of the flux pocket box through the cover plate hole to perform the welding operation. The flux pocket box is one of the components of the flux pocket device, which is configured to contain and store flux. The top of the box is provided with a removable cover plate, and the cover plate is provided with a welding gun hole. The cover plate hole is a through hole on the cover plate of the flux pocket box, which is used for the welding gun to enter the inside of the flux pocket box for welding operation.

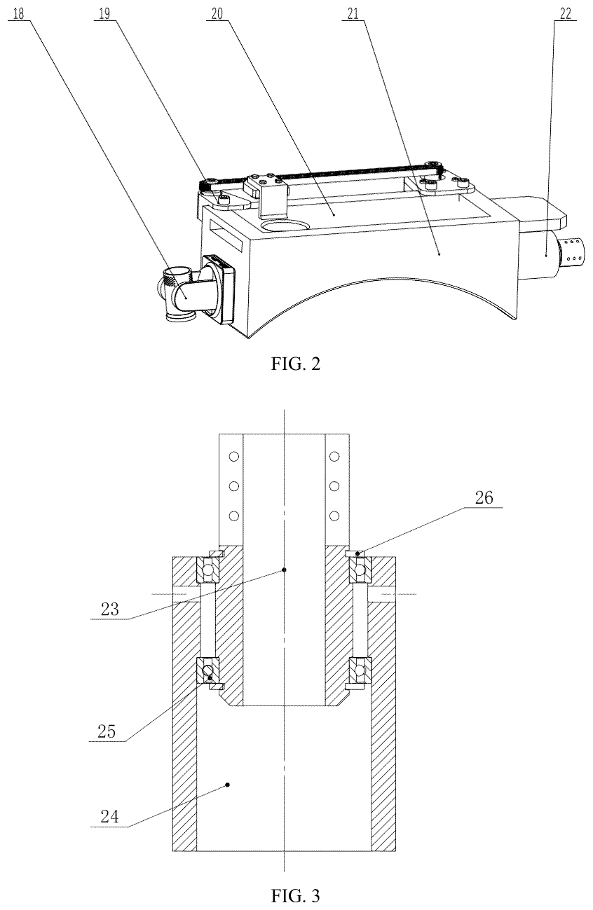

Please refer to FIG. 2, FIG. 2 is schematic structural diagram of the flux pocket device of the pipeline all-position submerged arc welding method according to an embodiment of the present application, which contains multiple key components to achieve precise control and supply of flux during welding. The device includes an industrial camera 18, a cover plate driving device 19, a flux pocket box body 21 and flux universal interface 22. The industrial camera 18 is used for capturing weld images and assisting in centering and correcting. The cover plate driving device 19 is responsible for driving the movable cover plate 20 to move along the flux pocket box body 21, ensuring that the welding gun can smoothly enter the flux box for welding operations, while ensuring that the flux is evenly deposited in the welding area. The flux pocket box body 21 is designed to accommodate and support the accumulation of flux, and its arc design is adapted to pipes of different diameters and shapes. The flux universal interface 22 allows the flux supply pipeline to rotate flexibly with the movement of the welding gun during welding, avoiding hose winding and ensuring the stability of flux supply. The entire device works cooperatively to provide an innovative solution for all-position submerged arc welding that adapts to complex welding conditions, accurately adjusts flux supply and reduces flux waste.

Please refer to FIG. 3, FIG. 3 is a schematic structural diagram of a flux rotating interface of the pipeline all-position submerged arc welding method according to an embodiment of the present application. The interface is the key connecting part of the flux pocket device, including a feed port fixing ring 23, a rotating sleeve 24, a ceramic bearing 25 and a bearing spring retaining ring 26. The function of the feed port fixing ring 23 is to fix the flux delivery pipeline and ensure its stability during the welding operation. The rotating sleeve 24 allows the pipeline to rotate flexibly as the welding gun moves during the welding process, while preventing the hose from being entangled, and ensuring the continuity and stability of the feeding system. The ceramic bearing 25 provides low-friction support for the rotational movement to ensure smooth flux delivery. The bearing spring retaining ring 26 ensures that the ceramic bearing remains in a fixed position during rotation to prevent displacement. This design effectively solves the problem of flux supply hose entanglement, ensures stable flux supply and precise positioning of the welding gun, and improves the automation degree and welding accuracy of the welding process.

Firstly, the submerged arc automatic welding system projects a laser line at the weld through a laser. The system calculates the adjustment amount based on the deviation between the laser line and the weld, drives the flux pocket device to move to achieve centering correction, ensures that the flux pocket device is accurately aligned with the weld, and provides an accurate flux supply position for subsequent welding. Secondly, the system uses the servo motor in the welding gun adjustment mechanism to adjust the up and down, left and right positions and rotation angles of the welding gun according to the relative positions of the welding gun and the cover plate hole detected by the proximity switch, so that the welding gun is accurately aligned with the hole on the cover plate of the flux pocket box, thereby ensuring that the welding gun can smoothly enter the flux box for welding operation.

Step S20, in response to that the welding gun is aligned with the cover plate hole, adjusting the flux hopper to a target height.

The flux hopper is mainly configured to contain and store flux, and transport the flux to the flux pocket box by its own weight or auxiliary gas pressure. The hopper is mounted at a liftable guide rail system and can be adjusted in height according to the requirements of the welding working conditions and the control system.

The target height refers to the optimal position to which the flux hopper needs to be adjusted during the welding process to ensure that the flux can smoothly flow into the flux pocket box and meet the welding process requirements.

Firstly, the system uses a Time of Flight (TOF) camera to measure the distance between the flux hopper and the top of the pipe to obtain basic data. Secondly, the system calculates the target height of the flux hopper by a preset formula. Finally, the system controls the motor to drive the belt transmission system to adjust the height of the flux hopper to the calculated target position, thereby ensuring the stability of the flux supply and the smooth progress of the welding process.

In an embodiment, the in response to that the welding gun is aligned with the cover plate hole, adjusting the flux hopper to the target height includes: measuring the distance between the flux hopper and the pipe to be welded by a rangefinder camera when the welding gun is aligned with the cover plate hole; and calculating the target height of the flux hopper based on the distance, the preset flux fluidity parameter and the preset hose diameter parameter, and adjusting the flux hopper to the target height.

The rangefinder camera refers to a TOF camera mounted at the feeding module, which is configured to measure the distance between the flux hopper and the pipe to be welded in real time. The TOF camera calculates the optical path to accurately measure the straight-line distance between the two by emitting lasers and receiving reflected signals.

The pipeline to be welded refers to a pipeline that is about to undergo welding operations, usually a chemical pipeline or other pipeline structure to be welded.

The preset flux fluidity parameter refers to a parameter pre-set according to the physical properties of the flux, which is configured to describe the resistance and fluidity of the flux during the flow process. Flux with poor fluidity has a larger fluidity coefficient, while flux with good fluidity has a smaller fluidity coefficient.

The preset hose diameter parameter refers to the diameter of the flux delivery hose, which is pre-set in the system. The size of the hose diameter affects the resistance to the flow of the flux, and a smaller hose diameter increases the resistance to the flow of the flux.

Firstly, after confirming that the welding gun is aligned with the cover plate hole, the system starts the rangefinder camera to measure the distance between the flux hopper and the pipeline to be welded in real time. Secondly, based on the measured distance, combined with the preset flux fluidity parameters and hose diameter parameters, the system determines the target height of the flux hopper through the following calculation formula to ensure that the flux can flow smoothly into the flux pocket box:

H_{funnel position}=H_{measured}+k_{f}·Dₕₒₛₑ+ΔH_{adjust}
where H_{measured} is the straight-line distance measured by the TOF camera. k_{f} is the flux fluidity coefficient, which reflects the flow characteristics of the flux. Dₕₒₛₑ is the diameter of the delivery hose. A smaller hose diameter will increase the resistance to flux flow, so the hopper position needs to be appropriately increased. ΔH_{adjust} is the adjustment coefficient of the welding condition. The hopper position is appropriately adjusted according to the welding position (such as overhead welding, vertical welding, etc.).

Finally, the system controls the motor-driven lifting device to adjust the flux hopper to the calculated target height, thereby optimizing the flux supply efficiency and ensuring the stability and welding quality of the welding process.

Step S30, in response to that the flux hopper reaches the target height, controlling a solenoid valve inside the flux hopper to adjust a flux accumulation amount according to a capacitance signal fed back by a capacitance probe inside the flux pocket box.

The capacitance probe is a sensor mounted inside the flux pocket box for real-time monitoring of the accumulation height of the flux. The probe determines the thickness of the flux by measuring the capacitance changes generated when the flux accumulates, and converts these changes into electrical signals to feed back to the submerged arc automatic welding system. These probes are arranged along the arc bottom surface of the flux box to ensure that the accumulation state of the flux can be fully monitored.

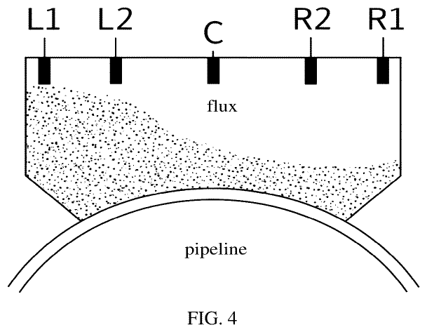

Please refer to FIG. 4, FIG. 4 is a schematic diagram of the distribution of capacitance probes in the flux bagging device of the pipeline all-position submerged arc welding method according to an embodiment of the present application. In the figure, the flux box is filled with flux, and the capacitance probes are marked as L1, L2, C, R1 and R2, which are evenly distributed inside the flux box and arranged along the arc bottom surface of the flux box. The sensing surfaces of these probes face the flux accumulation area and can monitor the accumulation height of the flux in real time. When the flux accumulates to a certain height, the capacitance between the flux and the probe will change, triggering a feedback signal. These signals are configured to control the supply of flux to ensure that the amount of flux accumulation is always maintained within the range required by the welding process. Through this multi-point monitoring, the system can achieve precise control of the flux supply, optimize the use of flux, reduce material waste, and improve the quality consistency and efficiency of the welding process.

The capacitive signal refers to the electrical signal generated by the change in flux accumulation height detected by the capacitance probe. When the flux accumulates to a certain height, the capacitance between the flux and the probe will change, thereby triggering a feedback signal. The trigger threshold of each capacitance probe is calibrated, and the system will compare the change in capacitance to determine whether the flux has reached the set accumulation requirement.

$${S}_{i} = \{ \begin{matrix}1 , & If the flux accumulation reaches the target height \\ 0 , & If the flux accumulation is insufficient\end{matrix}$$

Where sᵢ is the capacitance signal fed back by the i-th capacitance probe, cᵢ is the capacitance value of the i-th probe, and the threshold c_{threshold} is set.

cᵢ>c_{threshold}⇒sᵢ=1 (the flux has reached the standard)

cᵢ<c_{threshold}⇒sᵢ=0 (the flux is insufficient)

The solenoid valve is a control device mounted inside the flux hopper, which is configured to control the on-off of the flux flowing into the flux pocket box. By controlling the switch of the solenoid valve, the system can accurately adjust the flow of flux to ensure the stability and accuracy of the flux supply.

The flux accumulation amount refers to the actual accumulation height or volume of the flux in the flux pocket box. During the welding process, the flux accumulation amount needs to keep within a suitable range, usually 30 mm to 50 mm, to ensure the consistency and stability of the welding quality.

Firstly, after the flux hopper is adjusted to the target height, the system starts to monitor the capacitance signal fed back by the capacitance probe inside the flux pocket box. Then, the system controls the opening and closing of the solenoid valve according to the capacitance signal, thereby ensuring that the flux accumulation always keeps within the range required by the welding process.

In an embodiment, the in response to that the flux hopper reaches the target height, the controlling the solenoid valve inside the flux hopper to adjust the flux accumulation amount according to the capacitance signal fed back by the capacitance probe inside the flux pocket box includes: in response to that the flux hopper reaches the target height obtaining multiple capacitance signals fed back by multiple capacitance probes inside the flux pocket box; performing weighted averaging and filtering on the capacitance signals to obtain an average feedback signal; in response to that the average feedback signal does not reach the preset signal threshold keeping the solenoid valve inside the flux hopper open; and in response to that the average feedback signal reaches the preset signal threshold, closing the solenoid valve to adjust the flux accumulation amount.

The average feedback signal refers to the comprehensive signal obtained by the system after weighted averaging and filtering the capacitance signals fed back by multiple capacitance probes. This signal reflects the average state of the flux accumulation amount inside the flux pocket box. The average feedback signal s_{avg} calculation formula is:

$${S}_{avg} = \frac{1}{N} {\sum }_{i = 1}^{N} {S}_{i}$$

Where s_{avg} is the average feedback signal of all detection units, N is the number of detection units, if s_{avg}=1, it means that the flux accumulation has reached the standard; if s_{avg}=0, the flux accumulation is insufficient.

The preset signal threshold refers to a standard value pre-set by the system according to the welding process requirements, which is configured to determine whether the flux accumulation reaches the ideal welding condition.

Firstly, when the flux hopper adjusts to the target height, the system immediately collects the capacitance signals fed back by multiple capacitance probes in the flux pocket box, which reflect the accumulation height of the flux at different positions. Secondly, the system performs weighted averaging and filtering on these capacitance signals to eliminate noise interference in the signal and obtain a more accurate average feedback signal, which represents the overall state of the flux accumulation. Finally, the system compares the average feedback signal with the preset signal threshold. If the average feedback signal does not reach the preset signal threshold, it means that the flux accumulation is insufficient, and the system keeps the solenoid valve in the flux hopper open and continues to feed. If the average feedback signal reaches or exceeds the preset signal threshold, it means that the flux accumulation has met the welding requirements, and the system closes the solenoid valve and stops feeding, thereby ensuring that the flux accumulation always keep within the optimal range, and ensuring the stability of the welding process and the welding quality.

Before the in response to that the average feedback signal reaches the preset signal threshold, closing the solenoid valve to adjust the flux accumulation includes: obtaining the flux flow rate measured by the flow sensor; and adjusting the output pressure of the air pump outside the flux hopper according to the difference between the flux flow rate and the preset flow rate threshold.

The flux flow rate refers to the speed at which the flux flows out of the funnel and enters the flux pocket box, reflecting the flow state of the flux during the transportation process.

The preset flow rate threshold refers to the standard value of flux flow rate pre-set by the system according to the welding process requirements. This value is determined based on the flux supply and welding speed required during the welding process to ensure that the flux can flow into the flux pocket box at a suitable rate, thereby meeting the continuity and stability of the welding process.

The air pump is an auxiliary device mounted at the outside of the flux hopper, which is configured to provide additional air pressure when the flux flow is not smooth, helping the flux to flow smoothly into the flux pocket box. The output pressure of the air pump can be dynamically adjusted according to the real-time monitoring results of the flux flow rate to ensure the stability and continuity of the flux supply.

The output pressure refers to the air pressure intensity generated by the air pump when it is working. By adjusting the output pressure of the air pump, the flow rate and flow of the flux can be controlled.

Firstly, the system obtains the flux flow rate data in real time through the flow sensor mounted at the flux hopper or the conveying pipeline. This data reflects the actual flow rate of the flux during the conveying process. Secondly, the system compares the measured flux flow rate with the preset flow rate threshold and calculates the difference between the two. Finally, the system automatically adjusts the output pressure of the air pump outside the flux hopper according to this difference. If the flux flow rate is lower than the preset threshold, it means that the flux flow is not smooth, and the system will increase the output pressure of the air pump to promote the flux flow; if the flux flow rate is higher than the preset threshold, it means that the flux flows too fast, and the system will reduce the output pressure of the air pump to ensure that the flux flow rate is stable within the ideal range and the welding process is smooth.

Step S40, in response to that the flux accumulation amount reaches a preset accumulation amount threshold, starting the welding gun to start an arc and synchronously moving the welding gun and a cover plate of the flux pocket box until welding is completed.

The preset accumulation threshold refers to the standard value of the flux accumulation pre-set by the system according to the welding process requirements, which is configured to ensure that the accumulation height or volume of the flux during the welding process reaches the ideal range, thereby ensuring the welding quality.

Firstly, when the capacitance probe detects that the flux accumulation reaches the preset accumulation threshold, the system confirms that the flux supply is sufficient and uniform, and meets the welding conditions. Secondly, the system starts the welding gun, so that an arc is generated between the electrode of the welding gun and the workpiece, and the welding process begins. The arc start of the welding gun is triggered by sending a signal through the control system to trigger the welding power supply, so that the current passes between the welding wire and the workpiece, generating a high-temperature arc, thereby starting to melt the welding wire and the workpiece to form a weld. Then, the welding gun and the cover plate of the flux pocket box begin to move synchronously under the control of the drive system, the welding gun moves along the welding trajectory, and the cover plate also adjusts its position accordingly to ensure that the flux can evenly cover the welding area. Finally, the welding gun and the cover plate continue to move synchronously until the entire welding process is completed to ensure welding quality and efficiency.

This embodiment provides a pipeline all-position submerged arc welding method. Firstly, the system performs centering and deviation correction on the flux pocket device, and aligns the welding gun with the cover plate hole of the flux pocket box, so as to avoid welding defects caused by welding gun offset during welding and improve welding quality and efficiency. Secondly, when the welding gun is aligned with the cover plate hole, the system calculates the target height according to the preset formula, and then controls the lifting device driven by the motor to adjust the flux hopper to the height to ensure that the flux can flow smoothly into the flux pocket box to avoid poor flux flow or uneven accumulation due to inappropriate height. Then, after the flux hopper reaches the target height, the system obtains the capacitance signals fed back by multiple capacitance probes in the flux pocket box, controls the opening and closing of the solenoid valve according to the capacitance signals, realizes precise control of the flux accumulation, and ensures that the flux accumulation always meets the welding process requirements. Finally, when the flux accumulation reaches the preset accumulation threshold, the system starts the welding gun arc and synchronously moves the welding gun and the cover of the flux pocket box until the welding is completed, realizing the precise synchronous control of the uniform supply of flux in all positions and the welding path, avoiding welding defects caused by uneven flux, and ensuring the continuity and stability of the welding process.

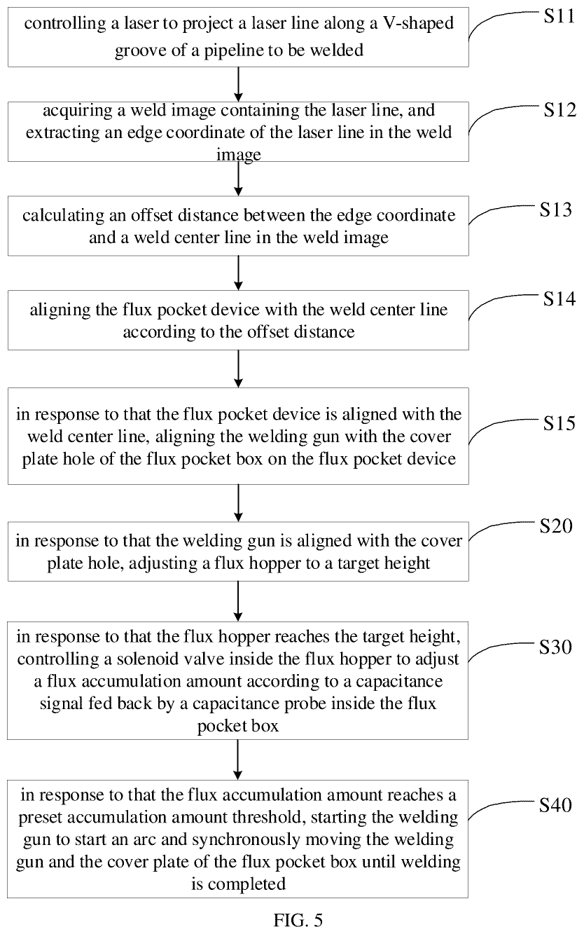

Based on the above embodiment of the present application, in another embodiment of the present application, the same or similar contents as those in the above-mentioned embodiment can refer to the above introduction, and will not be repeated later. On this basis, please refer to FIG. 5, FIG. 5 is a flowchart of the pipeline all-position submerged arc welding method according to another embodiment of the present application, and step S10 of the pipeline all-position submerged arc welding method includes steps S11 to S15.

Step S11, controlling a laser to project a laser line along a V-shaped groove of the pipeline to be welded.

The V-groove refers to a V-shaped cut pre-processed at the pipeline welding point. The V-groove is V-shaped and is usually formed by machining or cutting processes, which helps fill and fuse the weld, and ensures that the weld can be fully melted during the welding process, thereby improving the strength and quality of the welded joint.

Firstly, the system starts the laser to cause the laser to emit a laser beam. Then, the system precisely controls the direction of the laser beam to cause the laser to project a clear laser line along the V-groove of the pipe to be welded. This laser line will extend along the contour of the V-groove and cover the entire area to be welded. In this way, the laser line can not only clearly mark the position of the weld, but also provide an accurate positioning reference for subsequent welding operations, ensuring that the welding gun can accurately align the weld during welding. The laser is mounted at the top of the flux box, and the laser line is projected along the V-groove of the pipe. The direction of the laser line is aligned with the center line of the pipe, and it will be projected along the contour and edge of the weld to form a clear laser line. The center of this laser line is directly related to the center position of the weld. The projection of the laser line can be regarded as the equation of a straight line along the direction of the weld. Assuming the coordinates of the center line of the weld are (x_{center},y_{center}), and the projection angle θ of the laser line is the position of the laser line, which can be expressed by the parametric equation:

x=x_{center}+r cos(θ)

y=y_{center}+r sin(θ)

Where r is the offset from the weld. The accurate position of the weld can be obtained by projecting the laser line. The projection result of the laser line will form a clear light band on the surface of the pipeline. During welding, the image captured by the camera will be displayed as a light strip along the outline of the weld. In order to ensure alignment, the image processing system detects the position of the laser line in the image and calculates its deviation from the center of the weld.

Step S12, acquiring a weld image containing the laser line, and extracting an edge coordinate of the laser line in the weld image.

The weld image refers to an image containing the weld area captured by a camera mounted at the welding device. In the present embodiment, it not only includes the surface of the pipe to be welded, but also includes the laser line projected by the laser on the V-shaped groove.

The edge coordinate refers to the specific position information of the edge of the laser line extracted from the weld image by the image processing algorithm. These coordinate points represent the precise position of the laser line in the image, and usually expressed in pixels.

Firstly, the system captures the weld image containing the laser line through a camera mounted at the welding device to ensure that the image clearly shows the projection of the laser line on the V-shaped groove. Then, the system analyzes the weld image by using an image processing algorithm (such as a Canny edge detection algorithm) to extract the edge coordinates of the laser line.

In an embodiment, the obtaining a weld image containing the laser line and extracting the edge coordinate of the laser line in the weld image includes: acquiring the weld image containing the laser line, and graying the weld image and Gaussian filtering to obtain a target image; calculating a gradient amplitude and gradient direction of each pixel point in the target image; performing non-maximum suppression on the pixel point to obtain a suppressed pixel point according to the gradient amplitude and the gradient direction; screening the suppressed pixel point by a dual threshold detection algorithm, marking a pixel point with a gradient amplitude greater than a preset high gradient threshold as a strong edge point, and marking a pixel point with a gradient amplitude between a preset low gradient threshold and the preset high gradient threshold as a weak edge point; and obtaining the edge coordinate of the laser line according to the weak edge point, the strong edge point and the weld image.

The target image refers to the weld image after graying and Gaussian filtering.

The gradient amplitude refers to the gradient strength of each pixel point in the image, reflecting the magnitude of the grayscale change around the pixel point. In the edge detection, the larger the gradient amplitude is, the more drastic the grayscale changes around the pixel point, and the more likely it is an edge point. Given an image I(x, y), the gradient is calculated as:

$$G = \sqrt{{( \frac{\partial I}{\partial x} )}^{2} + {( \frac{\partial I}{\partial y} )}^{2}}$$

The gradient direction refers to the gradient direction of each pixel point in the image, indicating the direction of grayscale change. In edge detection, the gradient direction is configured to determine the direction of the edge and help the algorithm locate the edge more accurately. The gradient direction is usually determined by calculating the gradient components in the horizontal and vertical directions.

The preset high gradient threshold refers to a higher threshold set in the dual threshold detection algorithm, which is configured to distinguish strong edge points from non-edge points. In the present embodiment, the preset high gradient threshold is 0.8.

The strong edge points refer to pixel points whose gradient amplitude is greater than the preset high gradient threshold. These points represent areas with very drastic grayscale changes in the image and are likely to be part of the edge.

The preset low gradient threshold refers to a lower threshold set in the dual threshold detection algorithm, which is configured to distinguish weak edge points from non-edge points. In the present embodiment, the preset low gradient threshold is 0.2.

The weak edge points refer to pixel points whose gradient amplitude is between the preset low gradient threshold and the preset high gradient threshold. These points represent areas with relatively mild grayscale changes in the image and may be part of the edge, but may also be noise or other non-edge features, which require further verification. They are confirmed as edge points only when they are connected to strong edge points.

Firstly, the system obtains the weld image containing the laser line through the camera mounted at the welding device, and then grayscales the image, converting the color image into a grayscale image to reduce the amount of data and simplify the subsequent processing steps. Then, the system applies Gaussian filtering to remove noise in the image, smooth the image, and obtain a clear target image, providing a more accurate basis for subsequent edge detection. Secondly, the system calculates the gradient amplitude and gradient direction of each pixel point in the target image, calculates the gradient components of each pixel point in the horizontal and vertical directions respectively through the Sobel operator or other gradient operators, and then calculates the gradient amplitude and gradient direction based on these two components. Then, the system performs non-maximum suppression on each pixel point. By comparing the gradient amplitude of each pixel point with the neighboring pixel points in its gradient direction. If the gradient amplitude of the pixel point is not the local maximum, it is suppressed as a non-edge point, thereby retaining the true edge points and removing the pseudo edge points that may be caused by noise. Finally, screening the suppressed pixel points, and marking the pixel points with gradient amplitude greater than the preset high gradient threshold as strong edge points; marking the pixel points with gradient amplitude between the preset low gradient threshold and the high gradient threshold as weak edge points. Finally, the system determines the edge coordinates of the laser line by combining the strong edge points and the weak edge points and the original weld image, and provides accurate positioning information for subsequent weld centering and correction operations.

In an embodiment, the obtaining the edge coordinate of the laser line according to the weak edge point, the strong edge point and the weld image includes: connecting the weak edge point with the adjacent strong edge point based on the edge connection algorithm to form a continuous edge profile; fitting a straight line equation of the edge profile by Hough transform; and determining the edge coordinate of the laser line according to the intersection of the straight line equation and a boundary of the weld image.

The edge connection algorithm is an image processing technology configured to connect the weak edge points in the image with the adjacent strong edge points to form a continuous edge profile.

The edge profile refers to the continuous edge line formed by connecting weak edge points and strong edge points through edge connection algorithm. These edge lines clearly identify the boundaries or features of objects in the image, such as the specific position of the laser line in the weld image.

Hough transform is an algorithm for detecting straight lines in images. It realizes the detection of straight lines by converting edge points in the image from Cartesian coordinate system to parameter space (polar coordinate system). In parameter space, each straight line corresponds to a point. By statistically analyzing the distribution of these points, the most likely straight line parameters can be found.

The straight line equation refers to the mathematical expression describing the position of the laser line obtained by Hough transform fitting.

First, the system traverses all weak edge points through the edge connection algorithm. For each weak edge point, the system checks the pixels in its eight neighborhoods. If a strong edge point is found in the neighborhood, the weak edge point is connected to the strong edge point to form a continuous edge contour. This process effectively fills the broken parts that may appear in the edge detection and ensures that the edge of the laser line is clear and continuous. Secondly, the system applies Hough transform to the formed edge contour, converts each edge point into a sine curve in the parameter space, and counts the intersections of these curves in the parameter space. The parameters corresponding to the area with the most intersections are the slope and intercept of the straight line, thereby fitting the straight line equation of the edge contour. This process integrates the discrete edge points into a straight line, providing a mathematical basis for subsequent positioning. Finally, the system calculates the intersection points of the straight line and the boundary of the weld image according to the fitted straight line equation. these intersection points are the edge coordinates of the laser line. These coordinates can be configured to accurately determine the position of the laser line in the image, providing accurate positioning information for subsequent weld centering and correction operations, and ensuring the accuracy and stability of the welding process.

Step S13, calculating an offset distance between the edge coordinate and the weld center line in the weld image.

The weld centerline refers to the geometric center position of the weld in the image, which is usually predetermined by the image processing algorithm. In pipeline welding, the weld centerline is the key position that needs to be precisely aligned in the welding operation, and it represents the center trajectory of the weld.

The offset distance refers to the horizontal or vertical distance between the edge coordinate of the laser line and the weld centerline, which reflects the degree of alignment between the laser line and the weld centerline, and is an important basis for the system to determine whether the flux pocket device needs to be corrected.

Firstly, the system determines the coordinates of the center line of the weld through an image processing algorithm, usually using the Hough transform to extract the straight line equation of the center line from the weld image. Secondly, by calculating the Euclidean distance (or horizontal/vertical distance) between the edge coordinate point of the laser line and the corresponding point of the center line of the weld, the offset distance between the laser line and the center line of the weld can be obtained. The calculation formula is as follows:

d=\sqrt{(xₗₐₛₑᵣ−x_{center})²+(yₗₐₛₑᵣ−y_{center})²}

Where d is the offset distance, (xₗₐₛₑᵣ,yₗₐₛₑᵣ) is the coordinate of the center point of the laser line, and (xₗₐₛₑᵣ,yₗₐₛₑᵣ) is the coordinate of the center of the weld.

Step S14, aligning the flux pocket device with the weld centerline according to the offset distance.

Firstly, the system compares the calculated offset distance with the preset tolerance range to determine whether the position of the flux pocket device needs to be adjusted. Secondly, if the offset distance exceeds the tolerance range, the system adjusts the position of the flux pocket device through the driving device according to the direction and size of the offset, so that it moves toward the weld centerline until the offset distance is within the tolerance range. Finally, the system detects the alignment of the flux pocket device with the weld centerline again to ensure that the two are accurately aligned, providing accurate positioning for subsequent welding operations, thereby ensuring welding quality and efficiency.

In an embodiment, the aligning the flux pocket device with the weld centerline according to the offset distance includes: calculating a lateral adjustment amount of the flux pocket device according to the offset distance and the preset proportional gain coefficient; generating a pulse signal based on the lateral adjustment amount; and driving a motor of the flux pocket device to perform a lateral displacement with a preset adjustment cycle according to the pulse signal until an actual offset distance between the weld centerline and the flux pocket device is less than the preset alignment accuracy threshold, and the alignment is completed.

The preset proportional gain coefficient (Kₚ) refers to the coefficient configured to adjust the control amount in the proportional control algorithm. In the present embodiment, the value of Kₚ is 0.5, which is configured to calculate the lateral adjustment amount of the flux pocket device.

The lateral adjustment amount (ΔX) refers to the distance that the flux pocket device needs to move calculated based on the offset distance and the preset proportional gain coefficient, and the calculation formula is ΔX=Kₚ×offset distance. This value determines the lateral movement of the flux pocket device to ensure that the device can accurately align the center line of the weld.

The pulse signal refers to the control signal generated according to the lateral adjustment amount, which is configured to drive the motor to perform a specific displacement operation. The frequency and number of the pulse signal are proportional to the lateral adjustment amount. The speed and rotation angle of the motor are controlled by the pulse signal, thereby achieving precise displacement control.

The preset adjustment cycle refers to the time interval between each adjustment operation. In the present embodiment, the preset adjustment cycle is 100 milliseconds. This cycle determines the frequency of the system's position adjustment, ensuring that the adjustment process is smooth and not too frequent, thereby improving the stability and response speed of the system.

The lateral displacement refers to the actual lateral movement distance of the flux pocket device.

The actual offset distance refers to the real-time offset distance between the flux pocket device and the center line of the weld during the adjustment process. The system recalculates the actual offset distance after each adjustment to ensure the accuracy and effectiveness of the adjustment process.

The preset alignment accuracy threshold refers to the minimum offset distance at which the system considers the flux pocket device to be aligned with the center line of the weld. In the present embodiment, the preset alignment accuracy threshold is 0.5 mm.

First, the system calculates the lateral adjustment amount through a proportional control algorithm, specifically by multiplying the offset distance by a preset proportional gain coefficient to obtain the distance that the flux pocket device needs to move. The calculation formula is as follows:

$$\{ \begin{matrix}Δ x = k \cdot {d}_{x} \\ Δ y = k \cdot {d}_{y}\end{matrix}$$

Where k is the proportional coefficient, and dₓ and d_{y} are the deviation distances along the X-axis and Y-axis respectively.

Then, the system generates corresponding number of pulse signals according to this lateral adjustment amount, and each pulse signal corresponds to a step angle or movement unit of the motor to ensure that the angle of motor rotation accurately corresponds to the lateral adjustment amount. Finally, the system sends a pulse signal to drive the motor of the flux pocket device to perform lateral displacement at intervals of a preset adjustment cycle of 100 milliseconds. The displacement direction is determined according to the positive or negative offset distance, and the positive offset moves to the left and the negative offset moves to the right. After each adjustment, the system recalculates the actual offset distance until the actual offset distance is less than the preset alignment accuracy threshold of 0.5 mm, completes the alignment operation, ensures that the flux pocket device is accurately aligned with the center line of the weld, and provides accurate positioning for subsequent welding operations.

Step S15, in response to that the flux pocket device is aligned with the center line of the weld, aligning the welding gun with the cover plate hole of the flux pocket box on the flux pocket device.

First, after confirming that the flux pocket device is aligned with the center line of the weld, the system starts the welding gun alignment program, and adjusts the upper and lower positions of the welding gun according to the position information fed back by the proximity switch through the servo motor in the welding gun adjustment mechanism to ensure that the height of the welding gun is consistent with the cover plate hole. Secondly, the system continues to use the servo motor to adjust the left and right positions of the welding gun so that the center of the welding gun is aligned with the center of the cover plate hole, and adjusts the rotation angle of the welding gun to ensure that the welding gun can smoothly enter the cover plate hole.

This embodiment first controls the laser to project a laser line along the V-shaped groove of the pipe to be welded, clearly marking the weld position, providing a high-contrast reference for subsequent operations, and improving positioning accuracy. Next, obtaining the weld image containing the laser line, and after graying and Gaussian filtering the image, and extracting the edge coordinates of the laser line through gradient calculation and dual threshold detection to provide accurate data for the centering of the flux pocket device. Then, calculating the offset distance between the edge coordinate and the center line of the weld, calculating the lateral adjustment amount through the proportional control algorithm, and generating a pulse signal to drive the motor to adjust the position of the flux pocket device until the offset distance is less than the preset threshold, so as to achieve accurate centering and reduce welding deviation. Finally, when the flux pocket device is aligned with the center line of the weld, the servo motor is configured to adjust the up and down, left and right positions and rotation angles of the welding gun so that it is accurately aligned with the cover hole of the flux pocket box, ensuring that the welding gun can smoothly enter the cover hole for welding, avoiding welding defects, and further improving welding quality and efficiency.

The above embodiments are only configured to understand the present application and do not constitute a limitation on the pipeline all-position submerged arc welding method of the present application. More simple transformations based on this technical concept are all within the scope of the present application.

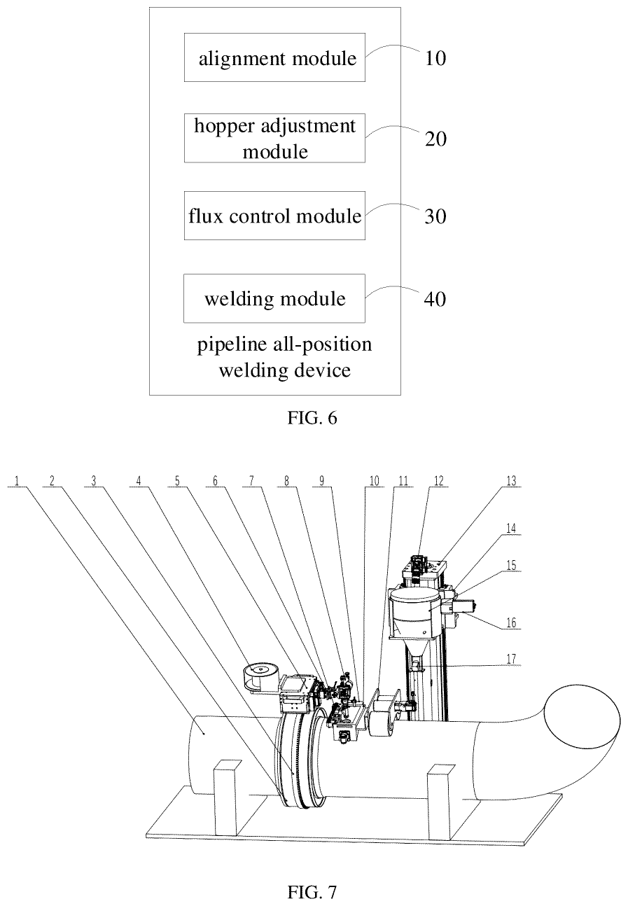

The present application also provides a pipeline all-position submerged arc welding device, please refer to FIG. 6, the pipeline all-position submerged arc welding device includes: an alignment module 10, a hopper adjustment module 20, a flux control module 30, and a welding module 40.

The alignment module 10 is configured to perform centering and deviation correction on the flux pocket device, and align the welding gun with the cover plate hole of the flux pocket box on the flux pocket device.

The hopper adjustment module 20 is configured to adjust the flux hopper to a target height in response to that the welding gun is aligned with the cover plate hole.

The flux control module 30 is configured to control the solenoid valve inside the flux hopper to adjust the flux accumulation amount according to the capacitance signal fed back by the capacitance probe inside the flux pocket box in response to that the flux hopper reaches the target height.

The welding module 40 is configured to start the welding gun to start an arc and synchronously move the welding gun and the cover plate of the flux pocket box until welding is completed in response to that the flux accumulation amount reaches a preset accumulation amount threshold.

In an embodiment, the alignment module 10 is also configured to control a laser to project a laser line along the V-shaped groove of the pipe to be welded; acquire a weld image containing the laser line, and extract the edge coordinates of the laser line in the weld image; calculate the offset distance between the edge coordinates and a weld center line in the weld image; align the flux pocket device with the weld center line according to the offset distance; and align the welding gun with the cover plate hole of the flux pocket box on the flux pocket device in response to that the flux pocket device is aligned with the weld center line.

In an embodiment, the alignment module 10 is also configured to acquire the weld image containing the laser line, and gray and Gaussian filter the weld image to obtain a target image; calculate a gradient amplitude and a gradient direction of each pixel point in the target image; perform non-maximum suppression on the pixel point to obtain a suppressed pixel point according to the gradient amplitude and the gradient direction; screen the suppressed pixel point by a dual threshold detection algorithm, mark a pixel point with a gradient amplitude greater than a preset high gradient threshold as a strong edge point, and marking a pixel point with a gradient amplitude between a preset low gradient threshold and the preset high gradient threshold as a weak edge point; and obtain the edge coordinates of the laser line according to the weak edge point, the strong edge point and the weld image.

In an embodiment, the alignment module 10 is also configured to connect the weak edge point with adjacent strong edge point based on an edge connection algorithm to form a continuous edge profile; fit the straight line equation of the edge profile by Hough transform; and determine the edge coordinate of the laser line according to an intersection of the straight line equation and a boundary of the weld image.

In an embodiment, the alignment module 10 is also configured to calculate a lateral adjustment amount of the flux pocket device according to the offset distance and a preset proportional gain coefficient; generate a pulse signal based on the lateral adjustment amount; and drive a motor of the flux pocket device to perform a lateral displacement at a preset adjustment cycle according to the pulse signal until an actual offset distance between the weld center line and the flux pocket device is less than the preset alignment accuracy threshold, and complete alignment.

In an embodiment, the funnel adjustment module 20 is also configured to measure a distance between the flux hopper and a pipeline to be welded by a rangefinder camera in response to that the welding gun is aligned with the cover plate hole; and calculate the target height of the flux hopper based on the distance, a preset flux fluidity parameter and a preset hose diameter parameter, and adjust the flux hopper to the target height.

In an embodiment, the flux control module 30 is also configured to obtain multiple capacitance signals fed back by multiple capacitance probes inside the flux pocket box in response to that the flux hopper reaches the target height; perform weighted averaging and filtering on the capacitance signals to obtain an average feedback signal; keep the solenoid valve inside the flux funnel open in response to that the average feedback signal does not reach the preset signal threshold; and close the solenoid valve to adjust the flux accumulation amount in response to that the average feedback signal reaches the preset signal threshold.

The pipeline all-position submerged arc welding device provided in the present application adopts the pipeline all-position submerged arc welding method in the above embodiment, which can solve the technical problem of how to achieve uniform supply of all-position flux and precise synchronous control of welding path. Compared with the related art, the beneficial effects of the pipeline all-position submerged arc welding device provided in the present application are the same as the beneficial effects of the pipeline all-position submerged arc welding method provided in the above embodiment, and other technical features in the pipeline all-position submerged arc welding device are the same as the features disclosed in the above embodiment method, which will not be repeated here.

The present application provides a submerged arc automatic welding system, which includes a circular track, a pipe to be welded, a flux pocket device, a welding gun, a flux hopper, a flux hopper fixed base, a rangefinder camera, a welding trolley circular track base, a welding wire reel, a welding trolley, a welding gun adjustment module, a flux baffle moving module, a flux baffle, a flux pocket box, a flux pocket box driving device, a flux hopper lifting module, a small air pump and a solenoid valve. The circular track is mounted at the outer surface of the pipe to be welded, and the flux pocket device is mounted at the weld of the pipe to be welded through a magnetic wheel.

Please refer to FIG. 7, FIG. 7 is a schematic structural diagram of the submerged arc automatic welding system according to an embodiment of the present application. As can be seen in the figure, the chemical pressure pipeline 1 is a object to be welded and is located at the bottom of the figure. The welding trolley circular track base 2 is firmly mounted at the pipeline to provide a moving track for the welding trolley 5. The circular track 3 surrounds the pipeline, and the welding trolley moves along the track to achieve all-position welding of the pipeline.

The welding wire reel 4 is mounted at the welding trolley to provide the welding wire required for welding. The welding gun adjustment module 6 is located at the front end of the welding trolley, which is configured to accurately adjust the position and angle of the welding gun 8 to ensure the accuracy of welding. The flux baffle moving module 7 and the flux baffle 9 work together to control the flow and coverage of the flux.

The flux pocket box 10 is mounted at the welding trolley to collect and guide the flux. The flux pocket box drive device 11 controls the movement of the pocket box to ensure that the flux can evenly cover the welding area. The TOF camera 12 is mounted at the outside of the flux pocket box to monitor the position of the weld and help the system to center and correct the flux pocket device.

The flux hopper lifting module 13 and the flux hopper fixed base 14 work together to enable the flux hopper 15 to rise and fall according to the welding requirements to adjust the supply of flux. The small air pump 16 and the solenoid valve 17 are mounted in the flux hopper to control the flow of flux and ensure that the flux can flow smoothly into the flux pocket box.

The entire system significantly improves welding accuracy and consistency by precisely controlling the flux supply and real-time monitoring of the flux accumulation state. The system can perform all-round welding at all positions on the pipeline, and is particularly suitable for chemical pipelines or pressure pipelines that cannot rotate, solving the problem that traditional welding methods cannot adapt to non-rotating pipelines.

The present application provides a computer-readable storage medium having computer-readable program instructions (i.e., computer programs) stored thereon, and the computer-readable program instructions are configured to execute the pipeline all-position submerged arc welding method in the above-mentioned embodiment.

The computer-readable storage medium provided in the present application may be, for example, a USB flash drive, but is not limited to electrical, magnetic, optical, electromagnetic, infrared, or semiconductor systems, systems or devices, or any combination thereof. More specific examples of computer-readable storage media may include, but are not limited to: an electrical connection with one or more wires, a portable computer disk, a hard disk, RAM (Random Access Memory), ROM (Read Only Memory), EPROM (Erasable Programmable Read Only Memory), optical fiber, CD-ROM (CD-Read Only Memory), optical storage device, magnetic storage device, or any suitable combination thereof. In the present embodiment, the computer-readable storage medium may be any tangible medium containing or storing a program, which may be used by or in combination with an instruction execution system, system or device. The program code contained in the computer-readable storage medium can be transmitted by any appropriate medium, including but not limited to: wires, optical cables, RF (Radio Frequency), etc., or any suitable combination of the above.

The above-mentioned computer-readable storage medium can be included in the pipeline all-position submerged arc welding device; or it can exist independently without being assembled into the pipeline all-position submerged arc welding device.

The computer-readable storage medium carries one or more programs. When the one or more programs are executed by the pipeline all-position submerged arc welding device, the pipeline all-position submerged arc welding device: performing centering and deviation correction on the flux pocket device, and aligns the welding gun with the cover plate hole of the flux pocket box on the flux pocket device; in response to that the welding gun is aligned with the cover plate hole, the flux hopper is adjusted to the target height; in response to that the flux hopper reaches the target height, controlling the solenoid valve inside the flux hopper according to the capacitance signal fed back by the capacitance probe inside the flux pocket box to adjust the flux accumulation amount; in response to that the flux accumulation amount reaches the preset accumulation amount threshold, starting the welding gun start the arc and the welding gun and the cover plate of the flux pocket box are synchronously moved until the welding is completed.

The computer program code for performing the operation of the present application can be written in one or more programming languages or a combination thereof, and the programming language includes object-oriented programming languages such as Java, Smalltalk, C++, and conventional procedural programming languages such as “C” language or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a LAN (Local Area Network) or a WAN (Wide Area Network), or may be connected to an external computer (e.g., connected through the Internet using an Internet service provider).

The flowcharts and block diagrams in the accompanying drawings illustrate the possible architecture, functions, and operations of the systems, methods, and computer program products according to various embodiments of the present application. In this regard, each box in the flowchart or block diagram may represent a module, a program segment, or a portion of a code, which contains one or more executable instructions for implementing a specified logical function. It should also be noted that in some alternative implementations, the functions marked in the box may also occur in an order different from that marked in the accompanying drawings. For example, two boxes represented in succession may actually be executed substantially in parallel, and they may sometimes be executed in reverse order, depending on the functions involved. It should also be noted that each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The modules involved in the embodiments described in the present application can be implemented by software or by hardware. The name of the module does not constitute a limitation on the unit itself under certain circumstances.

The readable storage medium provided in the present application is a computer-readable storage medium, and the computer-readable storage medium stores computer-readable program instructions (i.e., computer programs) for executing the above-mentioned pipeline all-position submerged arc welding method, which can solve the technical problem of how to achieve uniform supply of flux in all positions and precise synchronous control of welding paths. Compared with the prior art, the beneficial effects of the computer-readable storage medium provided in the present application are the same as the beneficial effects of the pipeline all-position submerged arc welding method provided in the above-mentioned embodiment, which will not be repeated here.

The present application also provides a computer program product, including a computer program, and when the computer program is executed by a processor, the pipeline all-position submerged arc welding method described above is implemented.

The computer program product provided by this application can solve the technical problem of how to achieve uniform supply of flux in all positions and precise synchronous control of welding paths. Compared with the related art, the beneficial effects of the computer program product provided by this application are the same as the beneficial effects of the pipeline all-position submerged arc welding method provided by the above embodiment, which will not be repeated here.

The above description are only part of the embodiments of the present application, and do not limit the patent scope of the present application. All equivalent structural changes made by using the contents of the specification and drawings of the present application under the technical concept of the present application, or directly/indirectly applied in other related technical fields, are included in the patent protection scope of this application.

1. A pipeline all-position submerged arc welding method, comprising:
performing centering and correcting on a flux pocket device, and aligning a welding gun with a cover plate hole of a flux pocket box on the flux pocket device;
in response to that the welding gun is aligned with the cover plate hole, adjusting a flux hopper to a target height;
in response to that the flux hopper reaches the target height, controlling a solenoid valve inside the flux hopper to adjust a flux accumulation amount according to a capacitance signal fed back by a capacitance probe inside the flux pocket box; and
in response to that the flux accumulation amount reaches a preset accumulation amount threshold, starting the welding gun to start an arc and synchronously moving the welding gun and the cover plate of the flux pocket box until welding is completed;
wherein the in response to that the flux hopper reaches the target height, controlling the solenoid valve inside the flux hopper to adjust the flux accumulation amount according to the capacitance signal fed back by the capacitance probe inside the flux pocket box comprises:
in response to that the flux hopper reaches the target height, obtaining multiple capacitance signals fed back by multiple capacitance probes inside the flux pocket box;
performing weighted averaging and filtering on the capacitance signals to obtain an average feedback signal;
in response to that the average feedback signal does not reach a preset signal threshold, keeping the solenoid valve inside the flux hopper open; and
in response to that the average feedback signal reaches the preset signal threshold, closing the solenoid valve to adjust the flux accumulation amount.

2. The method according to claim 1, wherein the performing centering and correcting on the flux pocket device and aligning the welding gun with the cover plate hole of the flux pocket box on the flux pocket device comprises:
controlling a laser to project a laser line along a V-shaped groove of a pipeline to be welded;
acquiring a weld image containing the laser line, and extracting an edge coordinate of the laser line in the weld image;
calculating an offset distance between the edge coordinate and a weld center line in the weld image;
aligning the flux pocket device with the weld center line according to the offset distance; and
in response to that the flux pocket device is aligned with the weld center line, aligning the welding gun with the cover plate hole of the flux pocket box on the flux pocket device.

3. The method according to claim 2, wherein the acquiring the weld image containing the laser line and extracting the edge coordinate of the laser line in the weld image comprises:
acquiring the weld image containing the laser line, and graying and Gaussian filtering the weld image to obtain a target image;
calculating a gradient amplitude and a gradient direction of each pixel point in the target image;
performing non-maximum suppression on the pixel point to obtain a suppressed pixel point according to the gradient amplitude and the gradient direction;
screening the suppressed pixel point by a dual threshold detection algorithm, marking a pixel point with a gradient amplitude greater than a preset high gradient threshold as a strong edge point, and marking a pixel point with a gradient amplitude between a preset low gradient threshold and the preset high gradient threshold as a weak edge point; and
obtaining the edge coordinate of the laser line according to the weak edge point, the strong edge point and the weld image.

4. The method according to claim 3, wherein the obtaining the edge coordinate of the laser line according to the weak edge point, the strong edge point and the weld image comprises:
connecting the weak edge point with adjacent strong edge point based on an edge connection algorithm to form a continuous edge profile;
fitting a straight line equation of the edge profile by Hough transform; and
determining the edge coordinate of the laser line according to an intersection of the straight line equation and a boundary of the weld image.

5. The method according to claim 2, wherein the aligning the flux pocket device with the weld center line according to the offset distance comprises:
calculating a lateral adjustment amount of the flux pocket device according to the offset distance and a preset proportional gain coefficient;
generating a pulse signal based on the lateral adjustment amount; and
driving a motor of the flux pocket device to perform a lateral displacement at a preset adjustment cycle according to the pulse signal until an actual offset distance between the weld center line and the flux pocket device is less than a preset alignment accuracy threshold, and completing alignment.

6. The method according to claim 1, wherein the in response to that the welding gun is aligned with the cover plate hole, adjusting the flux hopper to the target height comprises:
in response to that the welding gun is aligned with the cover plate hole, measuring a distance between the flux hopper and a pipeline to be welded by a rangefinder camera; and
calculating the target height of the flux hopper based on the distance, a preset flux fluidity parameter and a preset hose diameter parameter, and adjusting the flux hopper to the target height.

7. (canceled)

8. A pipeline all-position submerged arc welding device, configured to implement the pipeline all-position submerged arc welding method according to claim 1, comprising:
an alignment module configured to perform centering and deviation correction on a flux pocket device, and align a welding gun with a cover plate hole of a flux pocket box on the flux pocket device;
a hopper adjustment module configured to adjust the flux hopper to a target height in response to that the welding gun is aligned with the cover plate hole;
a flux control module configured to control a solenoid valve inside the flux hopper to adjust a flux accumulation amount according to a capacitance signal fed back by a capacitance probe inside the flux pocket box in response to that the flux hopper reaches the target height; and
a welding module configured to start the welding gun to start an arc and synchronously move the welding gun and the cover plate of the flux pocket box until welding is completed in response to that the flux accumulation amount reaches a preset accumulation amount threshold.

9. (canceled)

10. A non-transitory computer-readable storage medium, wherein a computer program is stored on the storage medium, and when the computer program is executed by a processor, the pipeline all-position submerged arc welding method according to claim 1 is implemented.
